(19) United States
(12) Patent Application Publication
(10) Pub. No.: US 2015/0160776 A1
(43) Pub. Date: Jun. 11, 2015

(54) INPUT DEVICE, INPUT DISABLING METHOD, INPUT DISABLING PROGRAM, AND COMPUTER READABLE RECORDING MEDIUM

(71) Applicant: Sharp Kabushiki Kaisha, Osaka-shi, Osaka (JP)

(72) Inventor: Yuhsaku Ajichi, Osaka-shi (JP)

(73) Assignee: Sharp Kabushiki Kaisha, Osaka-shi, Osaka (JP)

(21) Appl. No.: 14/411,998

(22) PCT Filed: Jul. 18, 2013
(86) PCT No.: PCT/JP2013/069468

§ 371 Date: Dec. 30, 2014

(30) Foreign Application Priority Data
Sep. 18, 2012 (JP) 2012-204998

(51) Int. Cl. G06F 3/041; G06F 3/044

(52) U.S. Cl. CPC G06F 3/0416; G06F 3/044

(57) ABSTRACT

An input device with excellent usability is provided. An input device (1) has a display unit (10) and includes a touch panel (20) that detects an input operation for the display screen, a region identification unit (34) that identifies an operation target region in which an image that is a target of the input operation is displayed on the display screen, and a disabling unit (38) that disables an input operation for a region other than the operation target region identified by the region identification unit (34), among the input operations detected by the touch panel (20).

### TECHNICAL FIELD

The present invention relates to an input device, an input disabling method, an input disabling program, and a computer readable recording medium.

### BACKGROUND ART

Touch input devices that are provided with touch panels on display devices and to which data is input by operations with an object such as a finger or pen on the touch panels have been adopted in information processing devices such as notebook PCs, mobile terminals, PDAs, ATMs, and car navigation devices.

On a touch panel, an operation may be performed accidentally if the touch panel is touched carelessly. To respond to such a problem, a technique has been disclosed by which a malfunction due to an operation not intended by an operator is prevented.

An information input device in PTL 1 is a device to which information can be input by touching a touch panel disposed on a display screen with a pointer. The information input device has an input disabled region setting means and a display control means. The input disabled region setting means sets an input disabled region on part of the touch panel and the display control means relocates an object displayed on the display screen so as to keep away from the set input disabled region.

### CITATION LIST

### Patent Literature

PTL 1: Japanese Unexamined Patent Application Publication No. 2012-014648

### SUMMARY OF INVENTION

### Technical Problem

However, the technique in related art as described above has a problem as described below.

In the information input device in PTL 1, if an input disabled region is set in part of the touch panel display and a window to be operated is located in the input disabled region, the window must be out of the input disabled region by moving or resizing the window. Therefore, in the information input device in PTL 1, there is a problem in that when an input disabled region is determined, a window cannot be placed at the position of the region and it is impossible to perform work at a desired position.

The present invention aims at solving the above problem, and the object of the present invention is to provide an input device with excellent usability, an input disabling method, an input disabling program, and a computer readable recording medium.

### Solution to Problem

To solve the above problem, an input device according to one aspect of the present invention is an input device with a display screen and includes a detection unit that detects an input operation for the display screen, a region identification means that identifies an operation target region in which an image that is a target of the input operation is displayed on the display screen, and a disabling means that disables an input operation for a region other than the operation target region identified by the region identification means, among the input operations detected by the detection unit.

Moreover, to solve the above problem, an input disabling method according to one aspect of the present invention is an input disabling method for use in an input device with a display screen and includes a detection step of detecting an input operation for the display screen, a region identification step of identifying an operation target region in which an image that is a target of the input operation is displayed on the display screen, and a disabling step of disabling an input operation for a region other than the operation target region identified by the region identification step, among the input operations detected by the detection step.

### Advantageous Effects of Invention

According to one aspect of the present invention, the input device according to one aspect of the present invention includes the detection unit that detects an input operation for the display screen, the region identification means that identifies an operation target region in which an image that is a target of the input operation is displayed on the display screen, and the disabling means that disables an input operation for a region other than the operation target region identified by the region identification means, among the input operations detected by the detection unit.

According to one aspect of the present invention, the input disabling method according to one aspect of the present invention includes the detection step of detecting an input operation for the display screen, the region identification step of identifying an operation target region in which an image that is a target of the input operation is displayed on the display screen, and the disabling step of disabling an input operation for a region other than the operation target region identified by the region identification step, among the input operations detected by the detection step.

Accordingly, an effect of providing an input device with excellent usability and the like may be obtained.

### BRIEF DESCRIPTION OF DRAWINGS

FIG. 1 is a block diagram of an input device according to an embodiment of the present invention.

FIG. 2 is a schematic view of the input device according to the embodiment of the present invention.

FIG. 3 illustrates an operation target region in which an image that is a target of an input operation by a user is displayed.

FIG. 4 illustrates functions of a disabling unit according to the embodiment of the present invention.

FIG. 5 illustrates effects of the input device according to the embodiment of the present invention.

FIG. 6 is a flowchart for illustrating a disabling processing method in the input device.

### DESCRIPTION OF EMBODIMENTS

An input device 1 according to an embodiment of the present invention will now be described with reference to the drawings. In the following description, the same parts and components are given the same reference signs.

[Input Device]

FIG. 2 is a schematic view of the input device 1 according to the embodiment of the present invention. As illustrated in the drawing, the input device 1 includes at least a display unit 10 and a touch panel 20.

The display unit 10 is, for example, a thin flat panel display such as a liquid crystal display (LCD), plasma display panel (PDP), or organic EL (organic LED).

The touch panel 20 is a user interface that accepts touch panel operations by the user and may be, for example, a capacitive input panel. The capacitive touch panel detects an input position by a capacitance change due to a finger touch (or detection of a nearby image) on the input panel coated with a transparent conductive film.

The touch panel 20 may be a mesh structure type with copper wires or the like. In the touch panel 20 in this case, a surface electrode is a polygonal mesh pattern (structure) including polygons formed of lines printed with a mesh pattern silver paste, lines etched with a copper foil, lines plated with copper, or the like that are low-resistance conductors that can enhance sensitivity to capacitance control and have high mechanical strength.

Any of various types of touch panels may be thus used as the touch panel 20.

The touch panel 20 of a capacitive type will now be described. The touch panel 20 includes a glass 21, which is an insulating layer, and an X sensor 22 and a Y sensor 23, which are electrode layers (may be referred to below as an operation input unit 25 when there is no distinction between the X sensor 22 and the Y sensor 23). As the X sensor 22 and the Y sensor 23 disposed between the insulating layer glass 21 and the display unit 10, electrode patterns formed of two vertical and horizontal (XY) layers with transparent electrodes made of ITO or the like, or fine metal wires, are arranged on glass or plastic substrates. When the touch panel 20 is touched with a finger or pen, the touch panel 20 accurately determines a touched position by detecting a capacitance change near the position with the two vertical and horizontal sensors, which are the X sensor 22 and the Y sensor 23. Moreover, the touch panel 20 is capable of multipoint detection with many electrode sensors that lie vertically and horizontally (XY).

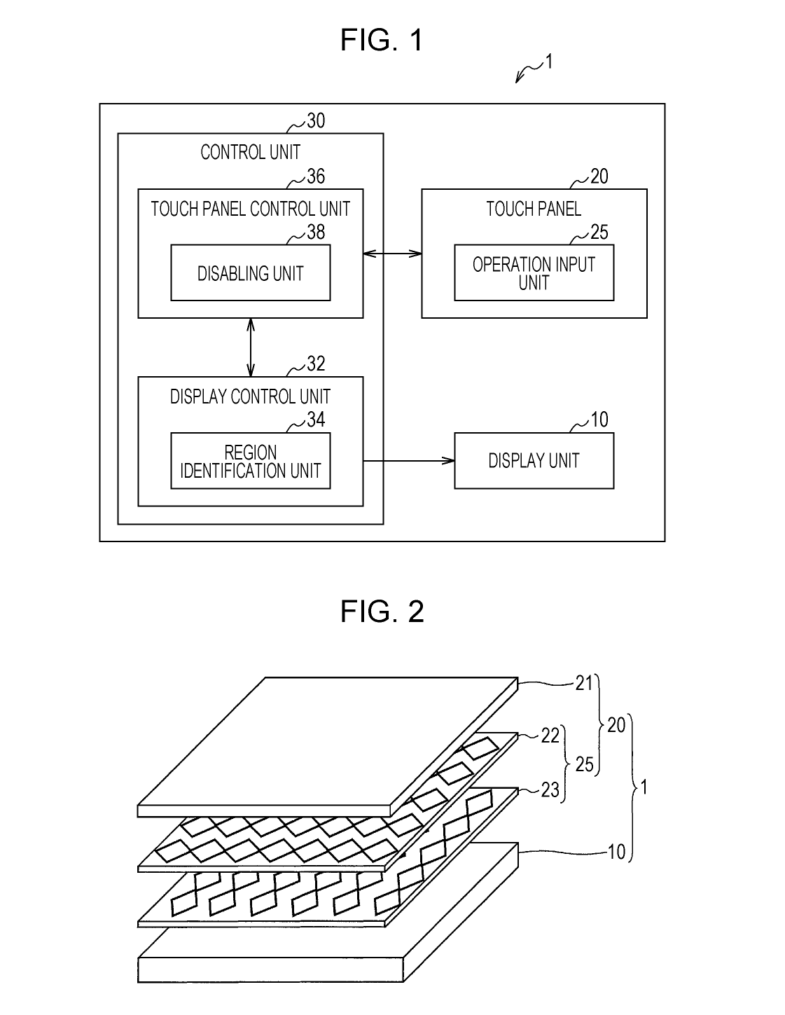

The input device 1 will now be described in more detail with reference to FIG. 1. FIG. 1 is a block diagram of the input device 1.

As illustrated in the drawing, the input device 1 includes the display unit 10, the touch panel 20, and a control unit 30 that controls display and input functions of the input device 1. Further, the control unit 30 includes a display control unit 32 and a touch panel control unit 36.

The display control unit 32 mainly controls the display of images (including moving images and still images) on the display unit 10, and includes at least a region identification unit 34.

The region identification unit 34 identifies an operation target region in which an image that is a target of an input operation by the user is displayed on the display screen of the display unit 10. Specifically, a plurality of working windows such as browsers, offices, menus, or task bars are displayed on the display unit 10, and the region identification unit 34 identifies, by coordinates, regions in which such working windows are displayed.

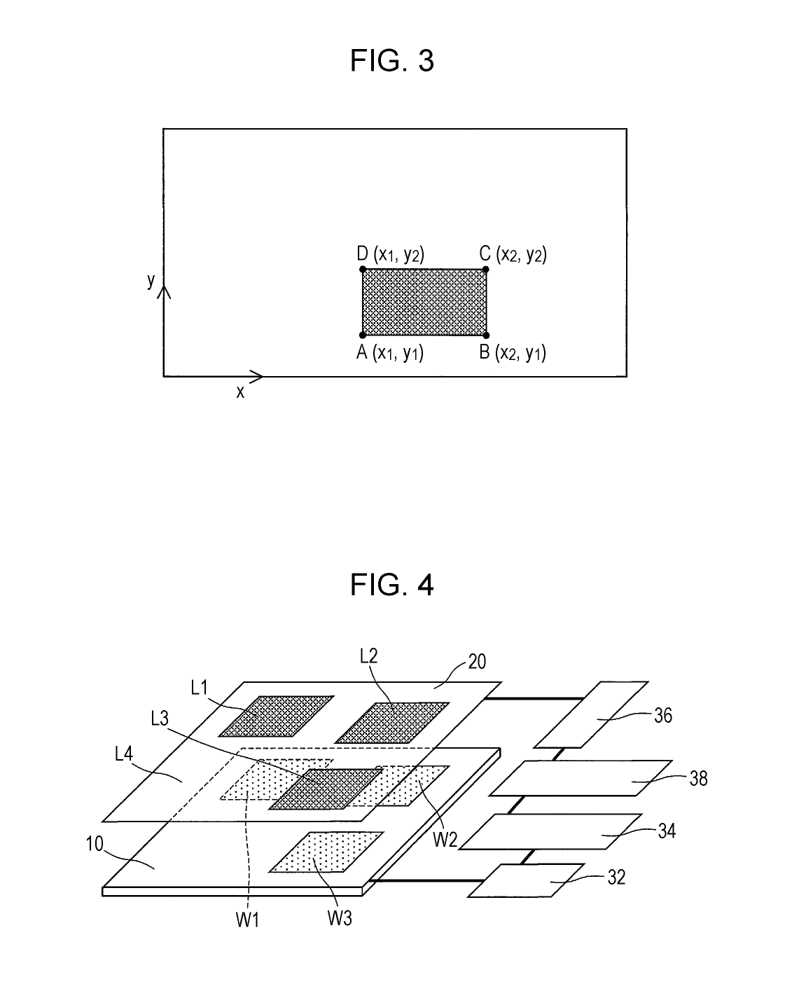

FIG. 3 illustrates an operation target region in which an image that is a target of an input operation by the user is displayed. For example, in FIG. 3, a rectangular display window ABCD is displayed on the display screen, and the coordinates of ABCD are defined as A (x1,y1), B (x2,y1), C (x2,y2), and D (x1,y2), respectively. Therefore, in the case of FIG. 3, the region identification unit 34 identifies ABCD defined by the above coordinates as an operation target region. That is, the region identification unit 34 identifies a region other than ABCD defined by the above coordinates as a region other than an operation target region (such a region may be referred to below as a “non-operation target region”).

As illustrated in FIG. 1, the region identification unit 34 outputs region identification information that indicates the identified operation target region and non-operation target region to the touch panel control unit 36 (specifically, the disabling unit 38).

As described above, the disabling unit 38 obtains the region identification information from the region identification unit 34. Moreover, the disabling unit 38 obtains input signals from the operation input unit 25 of the touch panel 20. The input signals include a signal indicating whether the user has touched the touch panel and a signal indicating a touched position when the touch panel has been touched.

Then, the disabling unit 38 disables an input operation for a non-operation target region identified by the region identification unit 34, among the operations detected by the touch panel 20.

More specifically, when the region identification unit 34 identifies coordinates indicating a region of a working window, the disabling unit 38 cuts a capacitance change in a region in which the working window does not exist (non-operation target region), thereby disabling a touch by the user in the non-operation target region. At the same time, the disabling unit 38 does not cut a capacitance change in a region in which the working window exists (operation target region), and enables a touch by the user in the operation target region.

The functions of the disabling unit 38 will be described in more detail with reference to FIG. 4. FIG. 4 illustrates the functions of the disabling unit 38.

As illustrated in the drawing, working windows W1, W2, and W3 are displayed on the display unit 10, and the region identification unit 34 identifies, by coordinates, operation target regions (working windows W1, W2, and W3) in which images that are targets of input operations by the user are displayed. That is, the region identification unit 34 can also identify non-operation target regions, which are regions other than the operation target regions in which the images that are the targets of the input operations by the user are displayed.

In this state, the user touches regions L1, L2, and/or L3 on the touch panel corresponding to operation target regions (working windows W1, W2, and/or W3). The disabling unit 38 does not cut a capacitance change in the regions L1, L2, and/or L3 on the touch panel, and directly accepts the input operations by the user. Then, processing corresponding to the input operations is performed and processing results are displayed on the display unit 10 under the control of the display control unit 32.

At the same time, for a user input for a region L4 on the touch panel corresponding to a non-operation target region, the disabling unit 38 cuts a capacitance change in the region L4, thereby disabling a touch by the user (input operation) for the non-operation target region.

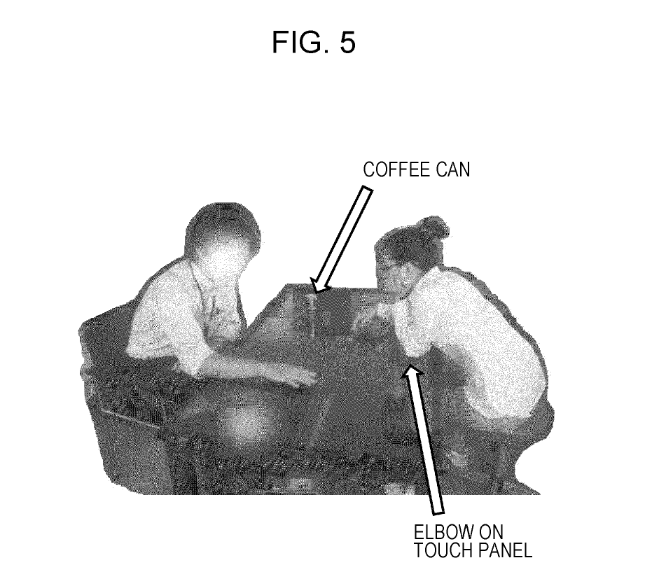

Effects of the input device 1 will now be described with reference to FIG. 5. FIG. 5 illustrates the effects of the input device 1.

As illustrated in the drawing, two persons face each other across the input device 1. In this case, a hand or elbow, or a coffee can may be placed on the input device 1 unintendedly. With a conventional input device, if an object such as a hand, elbow, or coffee can is placed on the touch panel unintendedly, the placement in itself may be recognized as an input operation, and the input device may perform processing not intended by the user in response to the input operation.

In contrast, in the input device 1, the disabling unit 38 disables an input operation for a region other than an operation target region in which a working window exists. Therefore, even if a conductive substance such as a coffee can is placed on the input device 1, the placement is not accepted as an input operation. Accordingly, as the input device 1, an input device with excellent usability is implemented that does not malfunction even if the touch panel is touched unconsciously with the hand, elbow, or the like.

[Other Examples of the Disabling Unit 38]

As described above, the disabling unit 38 cuts a capacitance change in a region in which a working window does not exist (non-operation target region), thereby disabling a touch by the user in the non-operation target region. However, the disabling unit 38 may be implemented in a configuration as described below.

Specifically, when an input operation is performed for a region other than an operation target region (non-operation target region), the disabling unit 38 restricts the function of detecting non-operation target regions in the touch panel 20.

That is, the disabling unit 38 controls the operation input unit 25 to prevent sensing by the touch panel 20 in the non-operation target regions.

In the above configuration, when the user touches an operation target region, input processing corresponding to the input operation is performed, and a result of the processing is displayed on the display unit 10. When the user touches a non-operation target region, sensing of the input operation by the operation input unit is prevented under the control of the disabling unit 38, and input processing corresponding to the input operation is not performed. Accordingly, as the input device 1, an input device with excellent usability may be implemented that does not malfunction even if the user touches the touch panel unconsciously with as the hand, elbow, or the like.

Further, the disabling unit 38 may be implemented in a configuration as described below.

Specifically, when the user touches a non-operation target region, the disabling unit 38 instructs the display control unit 32 to output a warning screen on the display unit 10. In response to this instruction, the display control unit 32 makes the display unit 10 display the warning screen asking, for example, “Are you sure you want to disable this input operation? Yes/No”. In response to this warning, the user touches a portion corresponding to “Yes” when the user wants to disable the input in the non-operation target region.

In the above configuration, when the user touches a non-operation target region, the disabling unit 38 first makes the display unit 10 display a warning screen and then prompts the user to check whether to enable or disable the touch. That is, if the user touches the non-operation target region unintendedly, the disabling unit 38 does not perform processing for the input operation, and temporarily suspends (restricts) the processing for the input operation. Then, after prompting the user to make a check, the disabling unit 38 removes the above restriction when the touch is enabled or maintains the above restriction when the touch is enabled.

In the above configuration, if the user touches a non-operation target region, the disabling unit 38 can restrict processing for the input. Accordingly, as the input device 1, an input device with excellent usability may be implemented that does not malfunction even if the user touches the touch panel unconsciously with the hand, elbow, or the like.

[Disabling Processing Method]

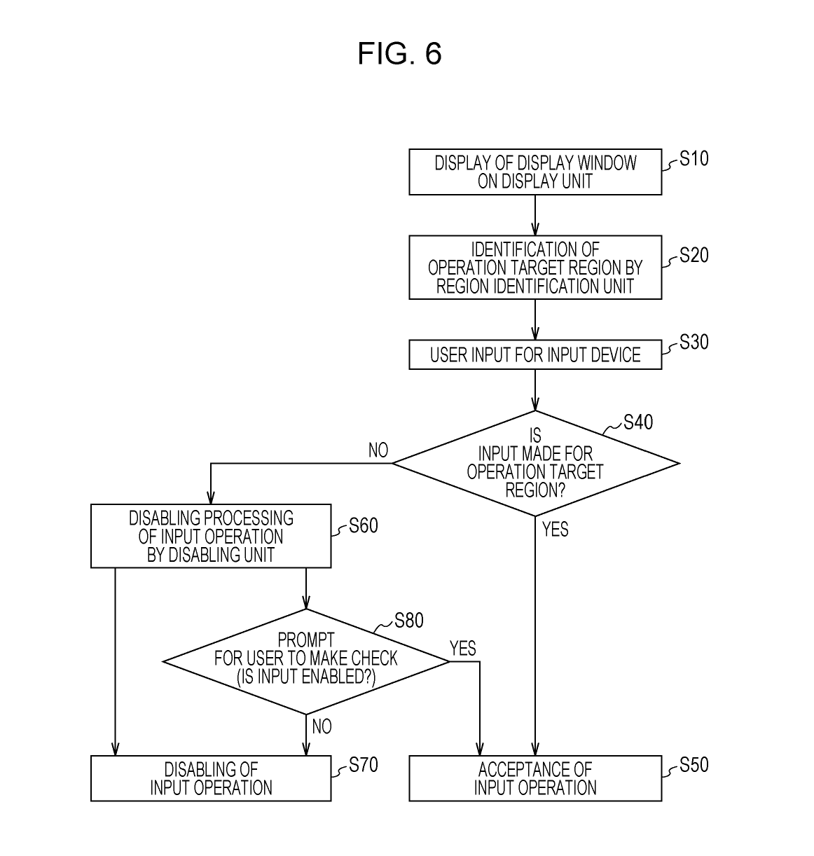

A flow of the disabling processing method will now be described with reference to FIG. 6. FIG. 6 is a flowchart for illustrating the disabling processing method in the input device 1.

In S10, a display window is displayed on the display unit 10. The display window includes an operation target region in which an image that is a target of an input operation by the user.

In S20, the region identification unit 34 identifies the operation target region in which the image that is the target of the input operation by the user is displayed on the display screen of the display unit 10.

In S30, the input operation by the user is performed for the input device 1.

In S40, the disabling unit 38 determines whether the input operation by the user in S30 is an input for the operation target region.

S50 corresponds to a case in which the input operation by the user is determined to be the input for the operation target region in S40, and the input operation is accepted in this case.

On the other hand, if the input operation by the user is determined not to be the input for the operation target region in S40, the flow proceeds to S60. In S60, the flow proceeds to S70 or S80 depending on the functions of the disabling unit 38.

S70 corresponds to a case in which the disabling unit 38 cuts a capacitance change in a non-operation target region, thereby disabling a touch by the user for the non-operation target region. Alternatively, S70 corresponds to a case in which the disabling unit 38 prevents sensing by the touch panel 20 in the non-operation target region.

In S80, when the user touches the non-operation target region, the disabling unit 38 instructs the display control unit 32 to output a warning screen on the display unit 10. In response to this instruction, the warning screen asking, for example, “Are you sure you want to disable this input operation? Yes/No” is displayed on the display unit 10. For “Yes”, the flow proceeds to S50 and the input operation is accepted. For “No”, on the other hand, the input operation is disabled.

Disabling processing is performed in the input device 1 in this manner. The effects of the disabling processing are as described above.

[Summary]

An input device according to one aspect of the present invention has a display screen (display unit 10) and includes a detection unit (touch panel 20) that detects an input operation for the display screen, a region identification means (region identification unit 34) that identifies an operation target region in which an image that is a target of the input operation is displayed on the display screen, and a disabling means (disabling unit 38) that disables an input operation for a region other than the operation target region identified by the region identification means, among the input operations detected by the detection unit.

An input disabling method according to one aspect of the present invention is for use in an input device with a display screen and includes a detection step of detecting an input operation for the display screen, a region identification step of identifying an operation target region in which an image that is a target of the input operation is displayed on the display screen, and a disabling step of disabling an input operation for a region other than the operation target region identified by the region identification step, among the input operations detected by the detection step.

In the above configuration, the input device according to one aspect of the present invention uses the disabling means (disabling step) to disable an input operation for a region other than the operation target region identified by the region identification means, among the input operations detected by the detection unit.

Therefore, if an input operation is performed for a region other than an operation target region, the disabling means (disabling step) disables the input operation, and thus the input operation performed accidentally can be rejected. That is, the input device according to one aspect of the present invention can enable only an input operation for the operation target region, and therefore improve the usability.

In the input device according to one aspect of the present invention, the detection unit may be a capacitive touch panel, and the disabling means may be configured to disable a capacitance change generated by an input for a region other than the operation target region.

In the above configuration, the input device according to one aspect of the present invention uses the disabling means to disable the capacitance change generated by the input for the region other than the operation target region, thereby disabling the input operation for the region other than the operation target region.

Accordingly, the input device according to one aspect of the present invention can disable the input operation for the region other than the operation target region, and improve the usability.

In the input device according to one aspect of the present invention, the disabling means may be configured to restrict the function of detecting an input operation for a region other than the operation target region.

In the above configuration, the input device according to one aspect of the present invention uses the disabling means to restrict the function of detecting the input operation for the region other than the operation target region, thereby disabling the input operation for the region other than the operation target region.

Accordingly, the input device according to one aspect of the present invention can disable the input operation for the region other than the operation target region, and improve the usability.

In the input device according to one aspect of the present invention, the disabling means may be configured to prompt the user to check whether to disable an input operation for a region other than an operation target region when that input operation is detected.

In the above configuration, the input device according to one aspect of the present invention uses the disabling means to prompts the user to check whether to disable the input operation for the region other than the operation target region when that input operation is detected.

That is, if the user unintendedly performs the input operation for the region other than the operation target region, the disabling means temporarily suspends acceptance of the input operation through the above check, thereby restricting processing corresponding to the input operation.

Therefore, even if the user touches the detection unit unintendedly with the hand, elbow, or the like, the input device according to one aspect of the present invention can prevent a situation in which processing for the input is performed suddenly.

In the input device according to one aspect of the present invention, the display screen may be configured to have an X axis and a Y axis set thereon, the region identification means may be configured to identify the operation target region by XY coordinates, and the disabling means may configured to disable an input operation for a region other than the operation target region defined by the XY coordinates.

In the above configuration, the input device according to one aspect of the present invention uses the disabling means to disable the input operation for the region other than the operation target region defined by the XY coordinates.

That is, the input device according to one aspect of the present invention can define, by the XY coordinates, the region other than the operation target region more accurately, thereby disabling an unintended input for the region other than the operation target region more accurately.

Accordingly, the input device according to one aspect of the present invention can further improve the usability.

The input device may be implemented by a computer. In this case, an input disabling program for implementing the input device in the computer by making the computer run as each of the means (detection step, region identification step, and disabling step) and a computer readable recording medium recording the input disabling program also fall into the category of the present invention.

[Supplement]

The input device according to an embodiment may be represented as described below.

The input device according to an embodiment may be configured to have a position detection unit that detects position coordinates (display regions) of at least one or more objects displayed on a display provided with a capacitive touch panel to which information can be input by touch operations and identifies the corresponding position coordinates on the touch panel. The input device may also be configured to disable a capacitance change due to an input in regions other than the regions on the touch panel corresponding to the display regions of the objects displayed on the display.

Moreover, the input device according to an embodiment may be configured to have a position detection unit that detects position coordinates (display regions) of at least one or more objects displayed on a display provided with a capacitive touch panel to which information can be input by touch operations and identifies the corresponding position coordinates on the touch panel. The input device may also be configured to prevent sensing by the touch panel in regions other than the regions on the touch panel corresponding to the display regions of the objects displayed on the display.

The present invention is not limited to the embodiments described above; various modifications may be made within the scope indicated in the claims, and embodiments obtained by appropriately combining the technical means disclosed in the different embodiments are also included in the technical scope of the present invention.

[Example of Implementation by Software]

Finally, the blocks of the input device 1, particularly the region identification unit 34 and the disabling unit 38, may be implemented by hardware using logic circuits formed on integrated circuits (IC chips), or may be implemented by software using a central processing unit (CPU).

In the latter case, the input device 1 includes the CPU that executes instructions in programs for implementing the functions, a read only memory (ROM) that stores the programs, a random access memory (RAM) into which the programs are loaded, a recording device (recording medium) such as a memory that stores the programs and various types of data, and the like. The object of the present invention may be accomplished also when the input device 1 is supplied with the recording medium that records program code (executable program, intermediate code program, and source program) of control programs for the input device 1 that are software programs for implementing the above functions, with the program code being recorded in a computer readable manner, and the computer (or the CPU or MPU) reads and executes the program code recorded on the recording medium.

As the recording medium, it is possible to use a non-transitory tangible medium, for example, any of tapes such as a magnetic tape and cassette tape, disks/discs including magnetic disks such as a Floppy® disk and hard disk and optical discs such as a CD-ROM, MO, MD, DVD, and CD-R, cards such as an IC card (including a memory card) and optical card, semiconductor memories such as a mask ROM, EPROM, EEPROM®, and flash ROM, or logic circuits such as a programmable logic device (PLD) and field programmable gate array (FPGA).

Moreover, the input device 1 may be configured to be capable of being connected to a communication network, and the program code may be supplied through the communication network. The communication network has only to transmit the program code, and does not have a specific limitation. For example, it is possible to use any of networks such as the Internet, an intranet, extranet, LAN, ISDN, VAN, CATV communication network, virtual private network, telephone line network, mobile communication network, and satellite communication network. Moreover, a transmission medium constituting the communication network also has only to transmit the program code, and is not limited to a medium of a specific configuration or type. For example, it is possible to use any of wired media such as an IEEE 1394 medium, USB medium, power line carrier, cable TV line, telephone line, and asymmetric digital subscriber line (ADSL), infrared media such as an IrDA medium and remote control, or wireless media such as a Bluetooth® medium, IEEE 802.11 wireless medium, High Data Rate (HDR) medium, Near Field Communication (NFC) medium, Digital Living Network Alliance (DLNA) medium, mobile telephone network, satellite line, and terrestrial digital network. The present invention may also be implemented in a form of computer data signals embedded in a carrier wave, with the program code being embodied in the computer data signals through electronic transmission.

### INDUSTRIAL APPLICABILITY

The present invention relates to an input device with excellent usability, an input disabling method, an input disabling program, and a computer readable recording medium.

### REFERENCE SIGNS LIST

1 input device
10 display unit
20 touch panel
21 glass
22 X sensor
23 Y sensor
25 operation input unit
30 control unit
32 display control unit
34 region identification unit (region identification means)
36 touch panel control unit
38 disabling unit (disabling means)
L1, L2, L3 operation target region
L4 non-operation target region

1-8. (canceled)

9. An input device with a display screen comprising:
a capacitive touch panel that detects an input operation for the display screen;
a region identification means that identifies an operation target region in which an image that is a target of the input operation is displayed on the display screen; and
a disabling means that disables a capacitance change generated by an input for a region other than the operation target region identified by the region identification means, among the input operations detected by the detection unit.

10. The input device according to claim 9,
wherein the disabling means includes restricting a function of detecting an input operation for a region other than the operation target region.

11. The input device according to claim 9,
wherein the disabling means prompts a user to check whether to disable an input operation for a region other than the operation target region when that input operation is detected.

12. The input device according to claim 9,
wherein the display screen has an X axis and a Y axis set thereon,
the region identification means identifies an operation target region by XY coordinates, and
the disabling means disables an input operation for a region other than the operation target region defined by the XY coordinates.

13. An input disabling method for use in an input device with a display screen comprising:
a detection step of using a capacitive touch panel that detects an input operation for the display screen;
a region identification step of identifying an operation target region in which an image that is a target of the input operation is displayed on the display screen; and
a disabling step of disabling an input operation for a region other than the operation target region identified by the region identification step, among the input operations detected by the detection step.

14. An input disabling program for making the input device according to claim 9 run, and making the computer function as each of the means.

15. A computer readable recording medium recording the input disabling program according to claim 14.
